(19) United States
(12) Patent Application Publication
(10) Pub. No.: US 2009/0098386 A1
(43) Pub. Date: Apr. 16, 2009

(54) CURABLE WATERBORNE FILM-FORMING COMPOSITIONS DEMONSTRATING IMPROVED POP RESISTANCE

(75) Inventors: Roxalana L. Martin, Pittsburgh, PA (US); Mark A. Tucker, Allison Park, PA (US); George Yakulis, JR., Allison Park, PA (US); Thomas R. Hockswender, Gibsonia, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/338,160

(22) Filed: Dec. 18, 2008

Related U.S. Application Data
(63) Continuation-in-part of application No. 11/754,694, filed on May 29, 2007.
Application No. 11/754,694 is a division of application No. 10/841,659, filed on May 7, 2004, now Pat. No. 7,241,830.

(51) Int. Cl. B32B 27/30; C09D 133/02; B32B 27/36

(52) U.S. Cl. 428/423.1; 525/386; 525/123; 428/500; 428/480

(57) ABSTRACT

The present invention is directed to waterborne curable film-forming compositions comprising a film-forming resin, a crosslinking agent, and an additive comprising isostearic acid neutralized with dimethylethanolamine. The compositions are essentially free of additives derived from reaction products of isocyanate functional materials and alkoxypolyalkylene compounds.

The present invention further provides multi-component composite coating compositions comprising a first film-forming composition applied to a substrate to form a primer or base coat, and a second film-forming composition applied on top of the primer or base coat to form a top coat, the top coat comprising the composition described above.

Coating compositions prepared from the curable compositions of the present invention demonstrate superior pop resistance properties, making them ideally suited for automotive applications.

### CROSS-REFERENCE TO RELATED APPLICATION

This application is a continuation-in-part of U.S. patent application Ser. No. 11/754,694, filed on May 29, 2007, and entitled “Organic Solvent-Free Film-Forming Compositions, Multi-Layer Composite Coatings, and Related Methods,” which in turn is a division of U.S. patent application Ser. No. 10/841,659, filed on May 7, 2004, now U.S. Pat. No. 7,241,830, both of which are incorporated herein in their entireties.

### FIELD OF THE INVENTION

The present invention relates to curable waterborne film-forming compositions prepared from acrylic polymers and a unique additive, demonstrating improved pop resistance.

### BACKGROUND OF THE INVENTION

Color-plus-clear coating systems that include a colored or pigmented base coat applied to a substrate followed by a transparent or clear topcoat applied on top of the base coat have long been the standard as original finishes for automobiles. The color-plus-clear systems have excellent aesthetic properties such as outstanding gloss and distinctness of image. The clear coat is particularly important for these properties.

Environmental concerns have also prompted development in recent years of coating compositions having low levels of organic solvents to minimize solvent emissions. Waterborne and powder coating compositions have been developed to meet these requirements. However, challenges still exist to develop low emissions compositions that meet appearance and performance requirements such as gloss, surface defect minimization, humidity resistance, etch resistance, etc., while using available components.

It would be desirable to provide new low emissions, curable film-forming compositions yielding cured coatings that exhibit excellent appearance properties such as pop resistance, while maintaining high gloss and other appearance and performance properties.

### SUMMARY OF THE INVENTION

The present invention is directed to waterborne curable film-forming compositions comprising (a) a film-forming resin, (b) a crosslinking agent, and (c) an additive comprising isostearic acid neutralized with dimethylethanolamine. The compositions are essentially free of additives derived from reaction products of isocyanate functional materials and alkoxypolyalkylene compounds. The compositions are emulsions prepared by subjecting a mixture of the components (a) and (b) to high shear stress conditions followed by addition of the additive (c) to the mixture.

The present invention further provides multi-component composite coating compositions comprising a first film-forming composition applied to a substrate to form a primer or base coat, and a second film-forming composition applied on top of the primer or base coat to form a top coat. The top coat comprises the waterborne composition described above.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention.

As used in the following description and claims, the following terms have the meanings indicated below:

By “polymer” is meant a polymer including homopolymers and copolymers, and oligomers. By “composite material” is meant a combination of two or more differing materials.

The term “curable”, as used for example in connection with a curable composition, means that the indicated composition is polymerizable or cross linkable through functional groups, e.g., by means that include, but are not limited to, thermal (including ambient cure) and/or catalytic exposure.

The term “cure”, “cured” or similar terms, as used in connection with a cured or curable composition, e.g., a “cured composition” of some specific description, means that at least a portion of the polymerizable and/or crosslinkable components that form the curable composition is polymerized and/or crosslinked. Additionally, curing of a polymerizable composition refers to subjecting said composition to curing conditions such as but not limited to thermal curing, leading to the reaction of the reactive functional groups of the composition, and resulting in polymerization and formation of a polymerizate. When a polymerizable composition is subjected to curing conditions, following polymerization and after reaction of most of the reactive groups occurs, the rate of reaction of the remaining unreacted reactive groups becomes progressively slower. The polymerizable composition can be subjected to curing conditions until it is at least partially cured. The term “at least partially cured” means subjecting the polymerizable composition to curing conditions, wherein reaction of at least a portion of the reactive groups of the composition occurs, to form a polymerizate. The polymerizable composition can also be subjected to curing conditions such that a substantially complete cure is attained and wherein further curing results in no significant further improvement in polymer properties, such as hardness.

The term “reactive” refers to a functional group capable of undergoing a chemical reaction with itself and/or other functional groups spontaneously or upon the application of heat or in the presence of a catalyst or by any other means known to those skilled in the art.

By “essentially free” of a material is meant that a composition has only trace or incidental amounts of a given material, and that the material is not present in an amount sufficient to affect any properties of the composition.

The curable film-forming compositions of the present invention comprise a film-forming resin, a crosslinking agent, and an additive comprising isostearic acid neutralized with dimethylethanolamine. In certain embodiments, the film-forming resin comprises an acrylic polymer prepared from monomers containing hydroxyl and acid functional groups. Useful hydroxyl functional monomers include hydroxyalkyl acrylates and methacrylates, typically having 2 to 4 carbon atoms in the hydroxyalkyl group, such as hydroxyethyl acrylate, hydroxypropyl acrylate, 4-hydroxybutyl acrylate, hydroxy functional adducts of caprolactone and hydroxyalkyl acrylates, and corresponding methacrylates. Useful ethylenically unsaturated acid functional monomers include monocarboxylic acids such as acrylic acid, methacrylic acid, crotonic acid; dicarboxylic acids such as itaconic acid, maleic acid and fumaric acid; and monoesters of dicarboxylic acids such as monobutyl maleate and monobutyl itaconate.

In certain embodiments of the present invention, the acrylic polymer is further prepared from an ethylenically unsaturated, beta-hydroxy ester functional monomer comprising a reaction product of an ethylenically unsaturated, epoxy functional monomer and isostearic acid. When present, this monomer is typically used in amounts up to 10 percent by weight of the total monomers used to prepare the acrylic polymer.

Suitable epoxy functional monomers used to prepare the ethylenically unsaturated, beta-hydroxy ester functional monomer include glycidyl acrylate, glycidyl methacrylate, allyl glycidyl ether, methallyl glycidyl ether, and the like. Glycidyl methacrylate is used most often. Isostearic acid may be reacted with the epoxy functional monomer to form the ethylenically unsaturated, beta-hydroxy ester functional monomer, which is then used to prepare the acrylic polymer.

Alternatively, an epoxy functional ethylenically unsaturated monomer such as any of those listed above may be used in the reaction mixture to prepare the acrylic polymer and then the epoxy functional groups in the resulting polymer may be post-reacted with isostearic acid.

Other monomers used to prepare the polymer in the film-forming resin include at least one ethylenically unsaturated monomer such as alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, and usually 4 to 18 carbon atoms in the alkyl group. Non-limiting examples include methyl methacrylate, ethyl methacrylate, butyl methacrylate, ethyl acrylate, butyl acrylate, lauryl methacrylate, isobornyl methacrylate, and 2-ethyl hexyl acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate.

Acrylic polymers can be prepared via aqueous emulsion polymerization techniques and used directly in the preparation of the aqueous coating compositions, or can be prepared via organic solution polymerization techniques with groups capable of salt formation such as acid or amine groups. Upon neutralization of these groups with a base or acid the polymers can be dispersed into aqueous medium. Generally any method of producing such polymers that is known to those skilled in the art utilizing art recognized amounts of monomers can be used.

In a particular embodiment of the present invention, the film-forming resin comprises an acrylic polymer prepared from 25 to 30 percent by weight styrene, 5 to 15 percent by weight 2-ethylhexyl acrylate, 15 to 20 percent by weight hydroxyethyl methacrylate, and 30 to 50 percent by weight, usually 40 to 43 percent by weight of a reaction product of acrylic acid and CARDURA E.

In certain embodiments of the present invention, the film-forming resin further comprises a polyester polyol. Such polymers may be prepared in a known manner by condensation of polyhydric alcohols and polycarboxylic acids. Suitable polyhydric alcohols include, but are not limited to, ethylene glycol, propylene glycol, butylene glycol, 1,6-hexylene glycol, neopentyl glycol, diethylene glycol, glycerol, trimethylol propane, and pentaerythritol. Suitable polycarboxylic acids include, but are not limited to, succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used. Where it is desired to produce air-drying alkyd resins, suitable drying oil fatty acids may be used and include, for example, those derived from linseed oil, soya bean oil, tall oil, dehydrated castor oil, or tung oil.

Other functional groups such as amide, thiol, urea, carbamate, and thiocarbamate may be incorporated into the polyester or alkyd resin as desired using suitably functional reactants if available, or conversion reactions as necessary to yield the desired functional groups, provided the final product has at least some hydroxyl functional groups. Such techniques are known to those skilled in the art.

When the polyester polyol is present, it makes up 5 to 50 percent by weight of the film-forming resin (a), based on the total weight of resin solids in the film-forming resin.

The film-forming resin (a) typically makes up 10 to 90, often 25 to 75 percent by weight of the curable film-forming composition of the present invention, based on the total weight of resin solids in the curable film-forming composition.

The curable film-forming composition of the present invention further comprises a crosslinking agent. Suitable crosslinking materials include aminoplasts, polyisocyanates, polyacids, anhydrides and mixtures thereof. Useful aminoplast resins are based on the addition products of formaldehyde with an amino- or amido-group carrying substance. Condensation products obtained from the reaction of alcohols and formaldehyde with melamine, urea or benzoguanamine are most common and preferred herein. While the aldehyde employed is most often formaldehyde, other similar condensation products can be made from other aldehydes, such as acetaldehyde, crotonaldehyde, acrolein, benzaldehyde, furfural, glyoxal and the like.

Condensation products of other amines and amides can also be used, for example, aldehyde condensates of triazines, diazines, triazoles, guanadines, guanamines and alkyl- and aryl-substituted derivatives of such compounds, including alkyl- and aryl-substituted ureas and alkyl- and aryl-substituted melamines. Non-limiting examples of such compounds include N,N′-dimethyl urea, benzourea, dicyandiamide, formaguanamine, acetoguanamine, glycoluril, ammeline, 3,5-diaminotriazole, triaminopyrimidine, and 2-mercapto-4,6-diaminopyrimidine.

The aminoplast resins often contain methylol or similar alkylol groups, and in most instances at least a portion of these alkylol groups are etherified by reaction with an alcohol. Any monohydric alcohol can be employed for this purpose, including methanol, ethanol, propanol, butanol, pentanol, hexanol, heptanol, as well as benzyl alcohol and other aromatic alcohols, cyclic alcohols such as cyclohexanol, monoethers of glycols, and halogen-substituted or other substituted alcohols such as 3-chloropropanol and butoxyethanol. Many aminoplast resins are partially alkylated with methanol or butanol.

Particularly suitable aminoplast crosslinking agents are high imino-functional melamines such as CYMEL 327 available from Cytec Industries, and MAPRENAL MF 904, a methoxylated melamine formaldehyde resin available from INEOS Melamines, Inc.

Polyisocyanates that may be utilized as crosslinking agents can be prepared from a variety of isocyanate-containing materials. Often, the polyisocyanate is a blocked polyisocyanate. Examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols can also be used. Examples of suitable blocking agents include those materials which would unblock at elevated temperatures such as lower aliphatic alcohols including methanol, oximes such as methyl ethyl ketoxime, lactams such as caprolactam and pyrazoles such as dimethyl pyrazole. A particularly suitable crosslinking agent comprises a hexamethylene diisocyanate trimer blocked with dimethyl pyrazole, available from Baxenden Chemicals as TRIXEN E.

Examples of polycarboxylic acids that are suitable for use as the crosslinking agent in the curable film-forming composition of the present invention include those described in U.S. Pat. No. 4,681,811, at column 6, line 45 to column 9, line 54. Suitable polyanhydrides include those disclosed in U.S. Pat. No. 4,798,746, at column 10, lines 16-50, and in U.S. Pat. No. 4,732,790, at column 3, lines 41 to 57.

Generally, the crosslinking agent is present in an amount ranging from 10 to 90 percent by weight, based on the total weight of resin solids of the curable film-forming composition, often 15 to 50 percent by weight.

The curable film-forming composition of the present invention further comprises an additive (c) comprising isostearic acid neutralized with dimethylethanolamine. The additive may be incorporated into a solvent portion of the composition during formulation, or added as the last component after all other ingredients are mixed together as discussed below. The additive (c) typically makes up 0.5 to 5 percent by weight, often 0.5 to 2.5 percent by weight of the curable film-forming composition, based on the total weight of resin solids on the curable film-forming composition. In embodiments where the film-forming resin includes an acrylic polymer that is prepared from an ethylenically unsaturated, beta-hydroxy ester functional monomer comprising a reaction product of an ethylenically unsaturated, epoxy functional monomer and isostearic acid, lower amounts of the additive (c) may be used, such as 1 percent by weight.

The curable film-forming compositions of the present invention may contain adjunct ingredients conventionally used in coating compositions. Optional ingredients such as, for example, plasticizers, surfactants, thixotropic agents, anti-gassing agents, organic cosolvents, flow controllers, anti-oxidants, UV light absorbers and similar additives conventional in the art may be included in the composition. These ingredients are typically present at up to about 40% by weight based on the total weight of resin solids.

As noted above, the compositions of the present invention are essentially free of additives derived from reaction products of isocyanate functional materials and alkoxypolyalkylene compounds. Such additives have been used to improve certain application and performance properties, such as sag and crater resistance, and are disclosed in United States Patent Application Publication Number 20050249958. These additives are not necessary in the compositions of the present invention due to the presence of additives derived from isostearic acid.

The curable film-forming compositions of the present invention typically have a total solids content of about 40 to about 80 percent by weight. The compositions of the present invention will often have a VOC content of less than 4 percent by weight, typically less than 3.5 percent by weight and many times less than 3 percent by weight. The compositions of the present invention may be cationic, anionic, or nonionic, but typically are anionic.

The curable film-forming compositions of the present invention may contain color pigments conventionally used in surface coatings and may be used as high gloss monocoats; that is, high gloss pigmented coatings. By “high gloss” it is meant that the cured coating has a 20° gloss and/or a DOI (“distinctness of image”) measurement of at least about 80 as measured by standard techniques known to those skilled in the art. Such standard techniques include ASTM D523 for gloss measurement and ASTM E430 for DOI measurement.

Suitable color pigments that may be used in a monocoat include, for example, inorganic pigments such as titanium dioxide, iron oxides, chromium oxide, lead chromate, and carbon black, and organic pigments such as phthalocyanine blue and phthalocyanine green. Mixtures of the above mentioned pigments may also be used. Suitable metallic pigments include, in particular, aluminum flake, copper bronze flake, and metal oxide coated mica, nickel flakes, tin flakes, and mixtures thereof.

In general, the pigment is incorporated into the film-forming composition in amounts up to about 80 percent by weight based on the total weight of coating solids. The metallic pigment is employed in amounts of about 0.5 to about 25 percent by weight based on the total weight of coating solids.

In preparing compositions of the present invention, a dispersion of polymeric microparticles is prepared by mixing together the above-described components (a) and (b) under high shear conditions. The additive (c) comprising isostearic acid neutralized with dimethylethanolamine is added to the mixture after the high shear mixing takes place. As used herein, the term “high shear conditions” is meant to include not only high stress techniques, such as by the liquid-liquid impingement techniques discussed in detail below, but also high speed shearing by mechanical means. It should be understood that, if desired, any mode of applying stress to the pre-emulsification mixture can be utilized so long as sufficient stress is applied to achieve the requisite particle size distribution. Note that such high shear mixing is not required when the acrylic polymer in the film-forming resin (a) is prepared from an ethylenically unsaturated, beta-hydroxy ester functional monomer comprising a reaction product of an ethylenically unsaturated, epoxy functional monomer and isostearic acid.

Generally, the dispersion is prepared as follows. The film-forming resin (a), crosslinking agent (b) and, if desired, other ingredients such as neutralizing agents, external surfactants, catalysts, flow additives and the like are mixed together with water under agitation to form a semi-stable oil-in-water pre-emulsion mixture. Note that any aminoplasts that may be part of the crosslinking agent component (b) are not necessarily added to the pre-emulsion, but are preferably post-added after high stress mixing. For example, aminoplasts can be post-added in combination with the additive (c) comprising isostearic acid neutralized with dimethylethanolamine. The pre-emulsion mixture is then subjected to sufficient stress to effect formation of polymeric microparticles of uniformly fine particle size. Optionally, residual organic solvents may then be removed azeotropically under reduced pressure distillation at low temperature (i.e., less than 40° C.) to yield a substantially organic solvent-free stable dispersion of polymeric microparticles.

The dispersions of this embodiment of the present invention typically are prepared as “oil-in-water” emulsions. That is, the aqueous medium provides the continuous phase in which the polymeric microparticles are suspended as the organic phase.

The aqueous medium generally is exclusively water. However, for some polymer systems, it can be desirable to also include a minor amount of inert organic solvent which can assist in lowering the viscosity of the polymer to be dispersed. Typically, the amount of organic solvent present in the aqueous dispersion of the present invention is less than 20 weight percent, usually less than 5 weight percent and most often less than 2 weight percent based on the total weight of the dispersion. For example, if the organic phase has a Brookfield viscosity greater than 1000 centipoise at 25° C. or a W Gardner Holdt viscosity, some solvent can be used. Examples of suitable solvents which can be incorporated in the organic component are xylene, methyl isobutyl ketone and n-butyl acetate.

As was mentioned above, the mixture typically is subjected to the appropriate stress by use of a MICROFLUIDIZER® emulsifier, which is available from Microfluidics Corporation in Newton, Mass. The MICROFLUIDIZER® high-pressure impingement emulsifier is described in detail in U.S. Pat. No. 4,533,254, which is hereby incorporated by reference. The device consists of a high-pressure (up to about 1.4×105 kPa (20,000 psi)) pump and an interaction chamber in which emulsification takes place. The pump forces the mixture of reactants in aqueous medium into the chamber where it is split into at least two streams which pass at very high velocity through at least two slits and collide, resulting in the formation of small particles. Generally, the pre-emulsion mixture is passed through the emulsifier at a pressure of between about 3.5×104 and about 1×105 kPa (5,000 and 15,000 psi). Multiple passes can result in smaller average particle size and a narrower range for the particle size distribution. When using the aforesaid MICROFLUIDIZER® emulsifier, stress is applied by liquid-liquid impingement as has been described. As mentioned above other modes of applying stress to the pre-emulsification mixture can be utilized so long as sufficient stress is applied to achieve the requisite particle size distribution. For example, one alternative manner of applying stress would be the use of ultrasonic energy.

Stress is described as force per unit area. Although the precise mechanism by which the MICROFLUIDIZER® emulsifier stresses the pre-emulsification mixture to particulate it is not thoroughly understood, it is theorized that stress is exerted in more than one manner. It is believed that one manner in which stress is exerted is by shear, that is, the force is such that one layer or plane moves parallel to an adjacent, parallel plane. Stress can also be exerted from all sides as a bulk, compression stress. In this instance stress could be exerted without any shear. A further manner of producing intense stress is by cavitation. Cavitation occurs when the pressure within a liquid is reduced enough to cause vaporization. The formation and collapse of the vapor bubbles occurs violently over a short time period and produces intense stress. Although not intending to be bound by any particular theory, it is believed that both shear and cavitation contribute to producing the stress which particulates and homogenizes the pre-emulsification mixture.

The curable film-forming compositions of the present invention are typically curable at elevated temperatures. The film-forming compositions of the present invention alternatively may be used as automotive primers, electrodepositable primers, base coats, clear coats, and monocoats, as well as in industrial and other applications. They are most suitable as topcoats, in particular, clear coats and monocoats, by virtue of their high gloss and pop resistance properties as discussed below.

The compositions of the present invention may be applied over any of a variety of substrates such as metallic, glass, wood, and/or polymeric substrates, and can be applied by conventional means including but not limited to brushing, dipping, flow coating, spraying and the like. They are most often applied by spraying. The usual spray techniques and equipment for air spraying, airless spraying, and electrostatic spraying employing manual and/or automatic methods can be used. Suitable substrates include but are not limited to metal substrates such as ferrous metals, zinc, copper, magnesium, aluminum, aluminum alloys, and other metal and alloy substrates typically used in the manufacture of automobile and other vehicle bodies. The ferrous metal substrates may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used.

The compositions of the present invention may also be applied over elastomeric or plastic substrates such as those that are found on motor vehicles. By “plastic” is meant any of the common thermoplastic or thermosetting synthetic nonconductive materials, including thermoplastic olefins such as polyethylene and polypropylene, thermoplastic urethane, polycarbonate, thermosetting sheet molding compound, reaction-injection molding compound, acrylonitrile-based materials, nylon, and the like.

The multi-component composite coating compositions of the present invention comprise a first film-forming composition applied to a substrate and a second film-forming composition applied on top of the first. The first film-forming composition may be any film-forming composition known in the art, or it may alternatively be a curable film-forming composition of the present invention as described above. The second film-forming composition comprises a curable film-forming composition of the present invention as described above.

In certain embodiments, the present invention is directed to multi-component composite coating compositions comprising a basecoat deposited from a pigment-containing base coating composition, which can comprise any of the aforementioned curable coating compositions, and a topcoat deposited from any of the coating compositions of the present invention previously described above. The topcoating composition may be transparent after curing, such as in a color-plus-clear multi-component composite coating composition. The components used to form the topcoating composition in these embodiments can be selected from the coating components discussed above, and additional components also can be selected from those recited above. Again, one or both of the base coating composition and the top coating composition can be formed from the curable coating compositions of the present invention.

Before depositing any treatment or coating compositions upon the surface of the substrate, it is common practice, though not necessary, to remove foreign matter from the surface by thoroughly cleaning and degreasing the surface. Such cleaning typically takes place after forming the substrate (stamping, welding, etc.) into an end-use shape. The surface of the substrate can be cleaned by physical or chemical means, such as mechanically abrading the surface or cleaning/degreasing with commercially available alkaline or acidic cleaning agents that are well known to those skilled in the art, such as sodium metasilicate and sodium hydroxide. A non-limiting example of a cleaning agent is CHEMKLEEN 163, an alkaline-based cleaner commercially available from PPG Industries, Inc.

Following the cleaning step, the substrate may be rinsed with deionized water or an aqueous solution of rinsing agents in order to remove any residue. The substrate can be air dried, for example, by using an air knife, by flashing off the water by brief exposure of the substrate to a high temperature or by passing the substrate between squeegee rolls.

The substrate to which the composition of the present invention is applied may be a bare, cleaned surface; it may be oily, pretreated with one or more pretreatment compositions, and/or prepainted with one or more coating compositions, primers, etc., applied by any method including, but not limited to, electrodeposition, spraying, dip coating, roll coating, curtain coating, and the like.

Where the basecoat is not formed from a composition of the present invention (but the topcoat is formed from a curable coating composition of the present invention) the coating composition of the basecoat in the color-plus-clear system can be any composition useful in coatings applications, particularly automotive applications. The coating composition of the basecoat can comprise a resinous binder and a pigment and/or other colorant, as well as optional additives well known in the art of coating compositions. Nonlimiting examples of resinous binders are acrylic polymers, polyesters, alkyds, and polyurethanes.

The first film-forming compositions can be applied to any of the substrates described above by any conventional coating techniques such as those described above, but are most often applied by spraying. The usual spray techniques and equipment for air spraying, airless spray, and electrostatic spraying employing either manual or automatic methods can be used. Resultant film thicknesses may vary as desired.

After forming a film of the first composition on the substrate, the coating can be cured or alternatively given a drying step in which at least some of the solvent is driven out of the film by heating or an air drying period before application of the second film-forming composition. Suitable drying conditions may depend, for example, on the particular composition, and on the ambient humidity if the composition is water-borne.

The second composition can be applied to the first by any conventional coating technique, including, but not limited to, any of those disclosed above. The second composition can be applied to a cured or to a dried coating layer before the first composition has been cured. In the latter instance, the two coatings can then be heated to temperatures and for a time sufficient to cure both coating layers simultaneously.

A second topcoat coating composition can be applied to the first topcoat to form a “clear-on-clear” topcoat. The first topcoat coating composition can be applied over the basecoat as described above. The second topcoat coating composition can be applied to a cured or to a dried first topcoat before the basecoat and first topcoat have been cured. The basecoat, the first topcoat and the second topcoat can then be heated to cure the three coatings simultaneously.

It should be understood that the second transparent topcoat and the first transparent topcoat coating compositions can be the same or different provided that, when applied wet-on-wet, one topcoat does not substantially interfere with the curing of the other, for example, by inhibiting solvent/water evaporation from a lower layer. Moreover, both the first topcoat and the second topcoat can be the curable coating composition of the present invention. Alternatively, only the second topcoat may be formed from the curable coating composition of the present invention.

If the first topcoat does not comprise the curable coating composition of the present invention, it may, for example, include any crosslinkable coating composition comprising a thermosettable coating material and a curing agent.

Typically, after forming the first topcoat over the basecoat, the first topcoat is given a drying step in which at least some solvent is driven out of the film by heating or, alternatively, an air drying period or curing step before application of the second topcoat. Suitable drying conditions will depend on the particular film-forming compositions used.

In certain embodiments of the present invention, the curable film-forming compositions of the present invention, after being applied to a substrate as a coating and after curing, demonstrate high gloss as described above and improved pop resistance compared to a similar curable film-forming composition that does not contain an additive comprising isostearic acid neutralized with dimethylethanolamine.

The following examples are intended to illustrate various embodiments of the invention, and should not be construed as limiting the invention in any way.

### EXAMPLES

### Example 1

A hydroxyl functional acrylic polymer was prepared from the following ingredients. The amounts listed are the total parts by weight in grams:

| INGREDIENTS | AMOUNTS |
|---|---|
| Charge I | |
| CARDURA E¹ | 618.6 |
| MIBK | 1025.1 |
| Charge II | |
| Hydroxyethyl methacrylate | 430.1 |
| 2-ethyl hexyl acrylate | 219.9 |
| Styrene | 616.5 |
| Acrylic acid | 286.4 |
| Charge III | |
| Di-t-amyl peroxide | 43.7 |
| MIBK | 183.77 |

¹glycidyl neodecanoate available from Shell Chemical Co.

Charge I was added to a suitable reactor and heated to 160° C. At this temperature Charges II and III were added, starting simultaneously, Charge II over 180 minutes and Charge III over 210 minutes. After the completion of Charge III, the contents of the flask were held for one hour at 160° C.

The finished product had 63.55% weight percent solids.

### Example 2

A hydroxyl functional acrylic polymer was prepared from the following ingredients. The amounts listed are the total parts by weight in grams:

| INGREDIENTS | AMOUNTS |
|---|---|
| Charge I | |
| Cardura E | 416.3 |
| MIBK | 100.0 |
| Charge II | |
| Methyl Methacrylate | 445.7 |
| Styrene | 544.1 |
| GMA/Isostearic Acid¹ | 194.0 |
| Hydroxyethyl Methacrylate | 76.5 |
| Charge III | |
| Eastman EEH Solvent | 125 |
| Di-T-Amyl Peroxide | 38.1 |
| DiPhenyl-2,4; Methyl-4 Pentene-1 | 56 |
| Charge IV | |
| Isobutyl Ketone | 875 |

¹Prepared by reacting 931.1 g isostearic acid with 468.6 g glycidyl methacrylate, in the presence of stannous octoate, triphenyl ester phosphorous acid, and hydroquinone monomethyl ether

Charge I was added to a suitable reactor and heated to 160° C. At this temperature Charges II and III were added, starting simultaneously, Charge II over 180 minutes and Charge III over 210 minutes. After the completion of Charge III, Charge IV was added and the contents of the flask were held for one hour at 160° C.

### Example 3 (Comparative)

A curable film-forming composition was prepared from the following ingredients. The amounts listed are the total parts by weight in grams:

| Ingredient | Amount |
|---|---|
| Acrylic¹ | 86.47 |
| Acrylic² | 74.26 |
| Tinuvin 1130³ | 1.87 |
| Tinuvin 292⁴ | 1.2 |
| Byk 325⁵ | .28 |
| Byk 355⁶ | .42 |
| Byk 345⁷ | 1.24 |
| Isostearyl Alcohol⁸ | 4.49 |
| Mapernal MF 904⁹ | 25.51 |
| Nacure 50768¹⁰ | 3.28 |
| Siloxane¹¹ | 2.49 |
| Adjust Viscosity | |
| Deionized Water | 16 |

¹Acrylic composed of 56% acrylic (containing 28.5% Neodecanoic Acid Glycidyl Ester, 10.1% Ethylhexyl Acrylate-2, 28.4% Styrene, 19.8% hydroxyethyl Methacrylate, 13.2% Glacial Acrylic Acid Inhibited), 44% DMP/HDI Trimer (Trixene commercially available from Baxenden, neutralized to 60% TN with DMEA, 0.06% Foam Kill 649, and 0.96% DBTDL
²Acrylic 23.38% Styrene, 25.32% EHA, 17.54% HEMA, 13.64% HBA, 17.54% E-Caprolactone, and 2.59% Acrylic Acid
³Tinuvin 1130 UV Light Stabilizer available from CIBA Specialty Chemical
⁴Tinuvin 292 UV Light Stabilizer available from CIBA Specialty Chemical
⁵Solution of Methylalkylpolysiloxane Copolymer available from Byk-Chemie USA
⁶Solution of Polyacrylate available from Byk-Chemie USA
⁷Polyether modified Polydimethyl Siloxane available from Byk-Chemie USA
⁸Isostearyl Alcohol Tego Alkanol 66 available from Goldschmidt Chemical., Tego Chemical
⁹Mapernal MF904 Methylated Melamine Formaldehyde available from Cytec Surface Specialties
¹⁰Nacure 5078 Solution of Alkyl Aromatic Sulfonic Acid available from King Industries
¹¹Siloxane polyol available from PPG Industries Inc.

### Example 4

A curable film-forming composition was prepared in accordance with the present invention from the following ingredients. The amounts listed are the total parts by weight in grams:

| Ingredient | Amount |
|---|---|
| Charge 1 | |
| Acrylic¹ | 86.47 |
| Acrylic² | 74.26 |
| Tinuvin 1130³ | 1.87 |
| Tinuvin 292⁴ | 1.2 |
| Byk 325⁵ | 0.28 |
| Byk 355⁶ | 0.42 |
| Byk 345⁷ | 1.24 |
| Isostearyl Alcohol⁸ | 4.49 |
| Mapernal MF 904⁹ | 25.51 |
| Nacure 50768¹⁰ | 3.28 |
| Siloxane¹¹ | 2.49 |
| Charge 2: | |
| Isostearic Acid¹² | 2.48 |
| DMEA¹³ | 0.75 |
| Charge 3: | |
| Di-Ionized Water | 16 |

¹Acrylic composed of 56% acrylic (containing 28.5% Neodecanoic Acid Glycidyl Ester, 10.1% Ethylhexyl Acrylate-2, 28.4% Styrene, 19.8% Hydroxyethyl Methacrylate, 13.2% Glacial Acrylic Acid Inhibited), 44% DMP/HDI Trimer (Trixene commercially available from Baxenden, neutralized to 60% TN with DMEA, 0.06% Foam Kill 649, and 0.96% DBTDL
²Acrylic 23.38% Styrene, 25.32% EHA, 17.54% HEMA, 13.64% HBA, 17.54% E-Caprolactone, and 2.59% Acrylic Acid
³Tinuvin 1130 UV Light Stabilizer available from CIBA Specialty Chemical
⁴Tinuvin 292 UV Light Stabilizer available from CIBA Specialty Chemical
⁵Solution of Methylalkylpolysiloxane Copolymer available from Byk-Chemie USA
⁶Solution of Polyacrylate available from Byk-Chemie USA
⁷Polyether modified Polydimethyl Siloxane available from Byk-Chemie USA
⁸Isostearyl Alcohol Tego Alkanol 66 available from Goldschmidt Chemical., Tego Chemical
⁹Mapernal MF904 Methylated Melamine Formaldehyde available from Cytec Surface Specialties
¹⁰Nacure 5078 Solution of Alkyl Aromatic Sulfonic Acid available from King Industries
¹¹Siloxane polyol available from PPG Industries Inc.
¹²Isostearyl Acid available from Cognis Emery Group
¹³DMEA Di-Methyl Ethanolamine available from Dow Chemicals

Charge 1 was added to a flask at ambient conditions and mixed until homogeneous. The temperature was increased to 25° C. The resulting pre-emulsion was passed once through a Microfluidizer® M110T (available from Microfluidics Corp., Newton, Mass.) at 11,500 psi with cooling water to maintain the pre-emulsion at approximately room temperature. Charge 2 was then added to the resulting emulsion. Charge 3 was then added to adjust viscosity.

### Test Substrates

The test substrates were ACT cold roll steel panels (4″×12″) supplied by ACT Laboratories, Inc. and were electrocoated with a cationic electrodepositable primer commercially available from PPG Industries, Inc., as ED 6060. The panels were spray coated with one coat of BASF Metrograu Base 1 commercially available from BASF to a film thickness ranging from 0.6 to 0.8 mils. The Base 1 was flashed at ambient temperature and then baked 5 minutes at 176° F. (80° C.). The substrate was then cooled to ambient temperatures. After cooling, BASF Polar Silber Base 2 commercially available from BASF, was applied to a film thickness ranging from 0.4 to 0.6 mils. The Base 2 was flashed at ambient temperatures and then baked 7 minutes at 176° F. (80° C.). The substrate was then cooled to ambient temperature. After cooling, film-forming composition of Examples 3 and 4 were spray applied, with a target film thickness of 1.5 to 2.0 mils, in 1 coat. The coated substrates were cured for 23 minutes in an oven set at 311° F. Appearance and properties for the coating are reported in the Data Table below.

### Data Table

Data Table

| | Example 3 | Example 4 |
|---|---|---|
| Gloss | 90 | 90 |
| Haze | 172 | 165 |
| DOI | 79 | 81 |
| Pop | 2.0 mils | 2.3 mils |
| Dullness | 26.5 | 23.4 |

Whereas particular embodiments of this invention have been described above for purposes of illustration, it will be evident to those skilled in the art that numerous variations of the details of the present invention may be made without departing from the scope of the invention as defined in the appended claims.

What is claimed is:

1. A waterborne, curable film-forming composition comprising:
a) a film-forming resin;
b) a crosslinking agent; and
c) an additive comprising isostearic acid neutralized with dimethylethanolamine, wherein the composition is essentially free of additives derived from reaction products of isocyanate functional materials and alkoxypolyalkylene compounds, and wherein the composition is an emulsion prepared by subjecting a mixture of the components (a) and (b) to high shear stress conditions followed by addition of the additive (c) to the mixture.

2. The curable film-forming composition of claim 1, wherein the film-forming resin comprises an acrylic polymer prepared from monomers containing hydroxyl and acid functional groups.

3. The curable film-forming composition of claim 2, wherein the film-forming resin further comprises a polyester polymer containing hydroxyl functional groups.

4. The curable film-forming composition of claim 1, wherein the crosslinking agent comprises an aminoplast, polyisocyanate, polyacid, and/or an hydride.

5. The curable film-forming composition of claim 4, wherein the crosslinking agent comprises a reaction product of hexamethylene diisocyanate trimer and dimethyl pyrazole.

6. The curable film-forming composition of claim 1, wherein the additive (c) is present in an amount of 0.5 to 5 percent by weight, based on the total weight of resin solids in the curable film-forming composition.

7. A multi-component composite coating composition comprising a first film-forming composition applied to a substrate to form a primer or base coat, and a second film-forming composition applied on top of the primer or base coat to form a top coat, wherein the second film-forming composition comprises a waterborne, curable film-forming composition comprising:
a) a film-forming resin;
b) a crosslinking agent; and
c) an additive comprising isostearic acid neutralized with dimethylethanolamine, and wherein the second film-forming composition is essentially free of additives derived from reaction products of isocyanate functional materials and alkoxypolyalkylene compounds, and wherein the second film-forming composition is an emulsion prepared by subjecting a mixture of the components (a) and (b) to high shear stress conditions followed by addition of the additive (c) to the mixture.

8. The multi-component composite coating composition of claim 7, wherein the first film-forming composition comprises a colored base coat, and the second film-forming composition comprises a colorless, transparent top coat.

9. The multi-component composite coating composition of claim 7, wherein the second film-forming resin comprises an acrylic polymer prepared from monomers containing hydroxyl and acid functional groups.

10. The multi-component composite coating composition of claim 9, wherein the second film-forming resin further comprises a polyester polymer containing hydroxyl functional groups.

11. The multi-component composite coating composition of claim 7, wherein the crosslinking agent comprises an aminoplast, polyisocyanate, polyacid, and/or anhydride.

12. The multi-component composite coating composition of claim 11, wherein the crosslinking agent comprises a reaction product of hexamethylene diisocyanate trimer and dimethylpyrazole.

13. The multi-component composite coating composition of claim 7, wherein the additive (c) is present in the second film-forming composition in an amount of 0.5 to 5 percent by weight, based on the total weight of resin solids in the second film-forming composition.
